(19) United States
(12) Patent Application Publication
(10) Pub. No.: US 2017/0188551 A1
(43) Pub. Date: Jul. 6, 2017

(54) Window Enclosure To Place And Operate An Aquarium, Animal Or Plant Terrarium

(71) Applicants: Sy Goron, Boynton Beach, FL (US); Joel Goron, New York, NY (US)

(72) Inventors: Sy Goron, Boynton Beach, FL (US); Joel Goron, New York, NY (US)

(21) Appl. No.: 15/279,411

(22) Filed: Sep. 28, 2016

Related U.S. Application Data
(60) Provisional application No. 62/233,468, filed on Sep. 28, 2015.

(51) Int. Cl. A01K 63/00; E06B 7/28

(52) U.S. Cl. CPC A01K 63/006; E06B 7/28

(57) ABSTRACT

Our invention is called WindowQuarium™, which is a weather-resistant enclosure that gets inserted and secured into a window frame, allowing an aquarium or terrarium tank to be installed and operated, eliminating the need for any stand or cabinet to hold the tank, and without occupying any square footage within the room. The design of the enclosure prevents additional sunlight from creating algae, and the combination of materials plus the air plenum and grill vents in the base allow internal air to flow into and around the enclosure and the accompanying aquarium tank, allowing the temperature of the tank to remain stable.

### CROSS-REFERENCE TO RELATED APPLICATIONS

This application claims the benefit of Applicant's prior U.S. Provisional Application No. 62/233,468, filed Sep. 28, 2015, the disclosure of which is incorporated herein by reference.

### FIELD OF INVENTION

The product relates to the general field of aquarium/terrarium tank furniture, and has specific application to tank placement and operation within a window frame.

### BACKGROUND OF THE INVENTION

This invention relates in general to a product and a method for placing and operating an aquarium or terrarium within a window frame at a physical property, such as a home, office, building or other structure or facility that could have an aquarium or terrarium on display.

Prior to our invention, aquariums were typically situated on a tank stand or cabinet, and the tank was not usually located very close to a window, as the sunlight and outside temperature can have adverse effects on the inhabitants of the tank. In fish tanks, sunlight creates algae blooms which deplete oxygen and require cleaning, and temperature changes will cause the fish to get sick and die. Furthermore, a tank stand or cabinet occupies floor space, which is often not readily available or desirable, preventing many people from purchasing the aquarium or terrarium they would love to have, given their limited space.

One current art is for a Window Aquarium Vessel, from inventor Jeff Miclea, U.S. Pat. No. 6,761,132, which is a slim aquarium tank that is installed into an interior wall and can be seen from both sides. Due to wall thickness, which is very thin, these vessels can only contain inhabitants that are extremely small in size. While this is a clever product that serves a specific purpose, it does not address the core issues that our invention solves.

Another current art is for an Aquarium Enclosure, from inventors Jeffrey Watters, David Lougee, and Anthony Thoes, U.S. Pat. No. Des. 326,935, which is essentially an ornamental design for an aquarium cabinet stand that also has a backside and a top so that a fish tank is surrounded by 3 sides. This is a clever invention that has benefits, however it still takes up floor space and does not allow you to place your tank near a window.

Similarly, many different tank stands exist that are simple and sturdy metal stands that can be placed almost anywhere within a room, however they do occupy the floor space below the tank and they cannot be placed near a window as there's no protection for the tank from sunlight or temperature changes by the window.

Another current art that does save on space is a wall-mounted aquarium, however this is similar to the window aquarium vessel in that it is very shallow from front to back, significantly limiting the type and number of inhabitants that can be placed inside of it. It also cannot be placed very close to a window.

### SUMMARY

WindowQuarium™ is a revolutionary temperature-resistant and sunlight-resistant window enclosure that is inserted and then secured into a window frame (in a manner somewhat similar to installing an air conditioner into a window frame).

Once the enclosure is installed and secured, it enables an aquarium or terrarium tank to be placed, operated and maintained, creating a unique and aesthetically pleasing and custom designed visual environment, and at the same time, it is not occupying any valuable floor or counter space.

Because of the specific design of the enclosure, livestock in the tank, be it fish, coral or invertebrates, can be placed in close proximity to the window without the adversities typically associated with a tank being near a window, mainly being no temperature fluctuation which would be harmful or fatal to the fish, along with no excessive algae growth due to sunlight. This is also due to the air plenum and grills in the base of our enclosure, that allow room temperature air to be drawn into the base and then it gets distributed behind, up and around the tank, creating a room temperature air cushion inside the enclosure, surrounding the tank.

Our enclosure may be used by aquarium or terrarium enthusiasts at a residential home, in an office, or any other property with an exterior window. The tank that is placed in the enclosure can be a freshwater or saltwater aquarium for fish, coral, invertebrates or even aquatic plants, or it can be a terrarium for various small animals that are typically purchased at pet stores, such as snakes, spiders, lizards, guinea pigs, rabbits, turtles, and many other species of animals that are typically kept in a tank, cage or other similar confines.

### BRIEF DESCRIPTION OF THE DRAWINGS

FIG. 1 depicts the top section of the enclosure, comprised of 4 panels within a frame that will attach to the base and the window frame.

FIG. 2 shows a base that sits on and is secured to the window frame, on which an aquarium or terrarium tank will be placed.

FIG. 3 Illustrates the two previous FIGS. 1 and 2, assembled together.

FIG. 4 shows how the enclosure is positioned within a window frame, where an aquarium tank will be positioned, and how airflow will circulate around the aquarium tank.

FIG. 5 depicts the design and construction of the base frame.

FIG. 6 illustrates a top down view of the design of the base including air circulation gap at the back end.

FIG. 7 shows an elevated side view of the base section including vented side panels by the front.

FIG. 8 shows the leveling legs that will allow the base to make contact with the inside and outside of the window sill.

FIG. 9 depicts the frame of the top section.

FIG. 10 illustrates where weather-stripping will be placed to provide sealing.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

For our invention, we found a unique way to utilize and re-purpose the common window and window frame, which is architecturally designed and built with the structural integrity and strength to hold significant weight, to house such tanks. The first prototype of this invention was designed and created by the inventor for use in his own home. The inventor is an interior designer, and he wanted to have an aquarium in the “Great Room” of his home, however he did not want to place the aquarium on a tank stand or cabinet that did not fit in aesthetically with his existing interior design, nor did he want to lose any floor space to a tank stand or cabinet. While he considered building the aquarium into a wall, the layout of the room did not present any viable walls, and what was left were some windows that faced out to the back yard. Being in the custom home renovation and remodeling business for most of his career, he determined that he could build a “custom, 5-sided box” that he could insert into the window frame, similar to how an air conditioner is often placed and secured into a window frame. The weight of the enclosure and tank would be safely distributed due to the structural design of the window frame and window sill, and by using solid panels, insulation and creating a viable design of the actual enclosure, no light would enter into the enclosure, and there would be room-temperature airflow surrounding the tank to help regulate the temperature so that the livestock would not be affected by the outside temperature and weather conditions.

The inventors designed and then built the enclosure, installed and fastened it into the window frame, placed a fish tank into the enclosure and then filled it with freshwater and freshwater fish. The fish have been living in that environment for quite some time, and whenever a guest came to the home and saw this unique interior design environment, they asked where it was purchased and learned that the inventors had made it themselves. Eventually, they decided that this had the makings of a marketable product, they hired a mechanical engineer to help refine the design and ensure that it was structurally and thermally sound and was designed using desirable raw materials that could be used to manufacture to a customer's window frame specifications.

Since it has been said that “The window is the eye to the soul of the home”, imagine if you could put an exquisite fish, plant or small animal tank into and even partially out of your window frame, and not occupy any floor space within a room, and create an entirely new, unique and breathtaking way to enjoy the beauty these tanks provide? Introducing WindowQuarium™.

WindowQuarium™ is comprised of two main parts. *Note—While these window enclosures will be made to order per customer's window measurements, for our referenced enclosure, the window is 48″ wide. The standard WindowQuarium™ will have a 3″ overhang inside and a 6″ (supported) overhang outside, however customers may choose to alter these sizes as long as appropriate support brackets and or braces are used. This could mean a flush front or a deeper or shallower front overhang as well as deeper or shallower rear overhang.

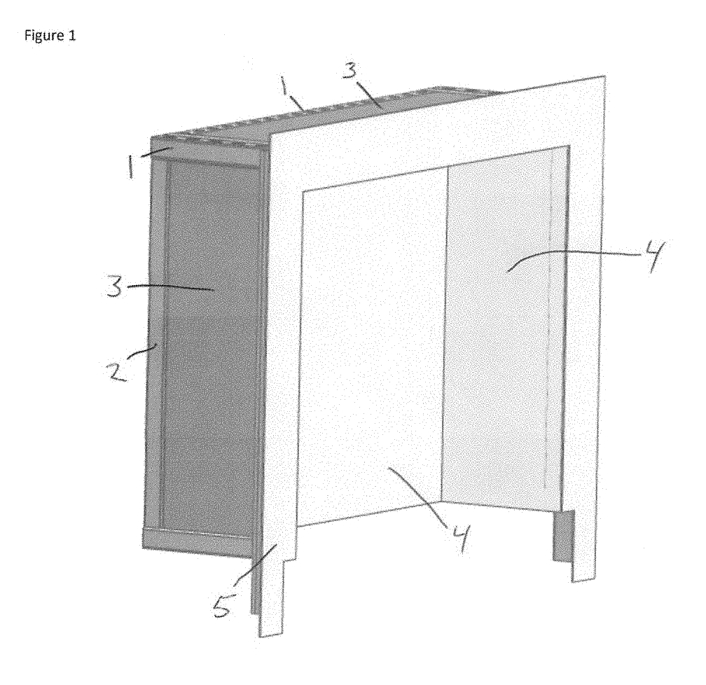

FIG. 1. The top section of the enclosure, which is an insulated wraparound comprised of a metal frame of T-channel 1 and corner channel 2 struts, acrylic, ABS or comparable outer top panel 3 and three outer side panels 3, that sits on top of a base and attaches to the base and the window frame. The interior panels 4 will be made of acrylic, ABS or comparable alternative material due to its glossy appearance and corrosion resistance. The interior panels will be offered in a variety of colors per customer's request. The top section stays in place once inserted into the window frame in part due to the portal frame or flange 5 that overlaps with the window frame, as it is manufactured specifically to overlap the window frame when installed, thus preventing the enclosure from being able to go out the window. The Top ASM will slide into the existing window frame using a matching channel. The channels will then be screwed into the existing wall. This will both secure the unit in place and help sealing.

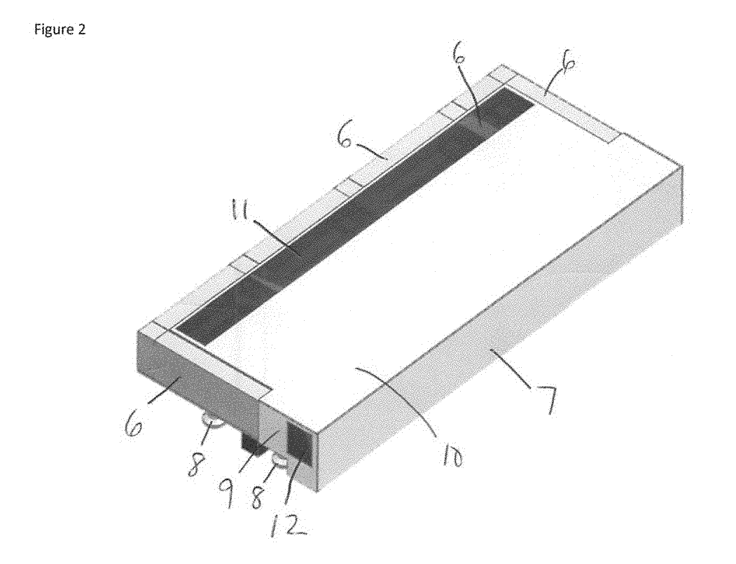

FIG. 2. The base section will consist of metal studs 6 that create a frame that is encased by top and bottom metal panels 10, creating an air plenum platform that sits on and is secured to the window frame, on which an aquarium or terrarium tank sits on. A grill top 11 sits at the back of the top panel to enable the air plenum to deliver air up behind and around the tank. A plastic front panel 7 and left and right side panels 9 provide necessary continuity is the design, leveling legs 8 in front and behind the window frame provide added stability, and side grills or vents 12 towards the front of the base were engineered to route room temperature airflow around the tank.

The Top & Base ASM will be covered in a protective film to act as an additional layer of protection against water/vapor. The film will be secured using adhesive. The protective film will be applied to the frame+insulation assembly of WindowQuarium™. It will be sandwiched between the outside/inside acrylic panels and the frame.

The Outside Facing Panels will be made of acrylic due to its UV resistance, waterproofness and cost. The panels will either be bolted or snapped into place. A protective cover will follow the panel edges to provide additional weather protection. Caulk will be used at panel interfaces to guarantee adequate sealing. Panels will be offered in a variety of colors.

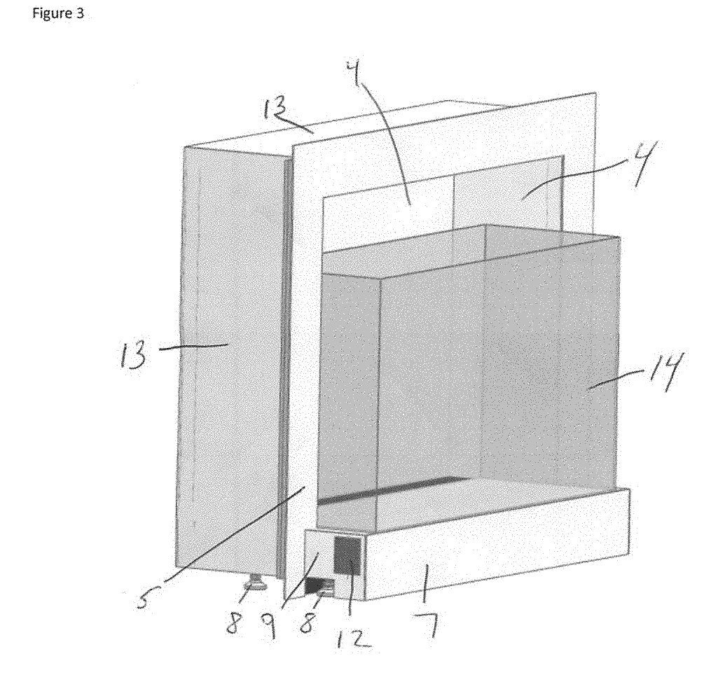

FIG. 3. Illustrates an isometric view of the two sections described in FIGS. 1 and 2, now shown fully assembled. This Illustration also depicts an aquarium or terrarium tank 14, which is not part of our product, but it is placed on/into the fully assembled enclosure once the enclosure is installed and secured.

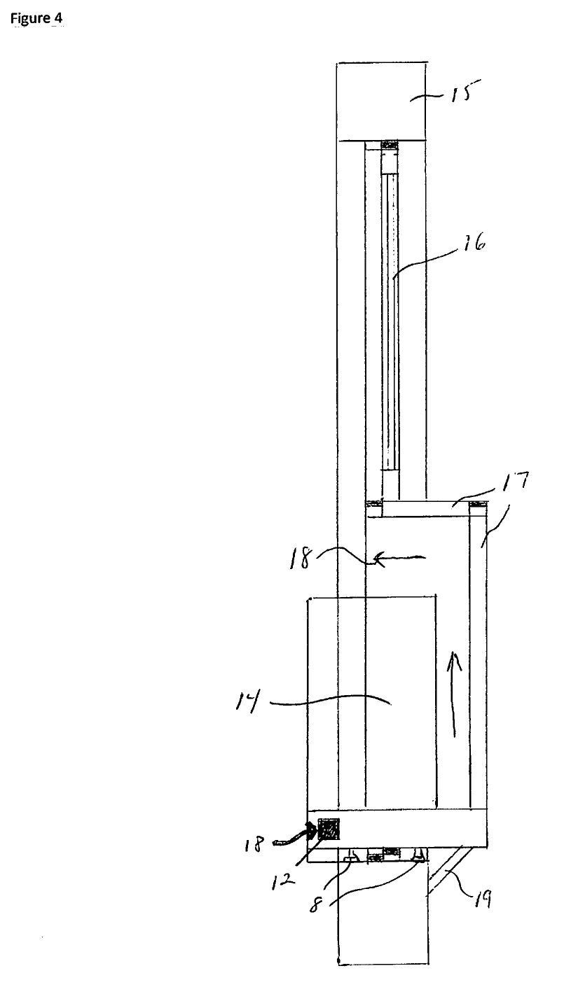

FIG. 4. Schematic shows a cutaway through side view wall. The wall 15 and window frame 16 are not part of our product but are instead part of the existing home, office or facility. The insulation 17 will sit inside the channel frame and will have a thickness of 1.5″. EPS/XPS will be used due to its availability and thermal properties. Air flow 18 routes in from the side grills 12—back, up and around the tank, creating a cushion of room temperature air. Support brackets 19 are added anytime a system is installed above ground level for added support and safety.

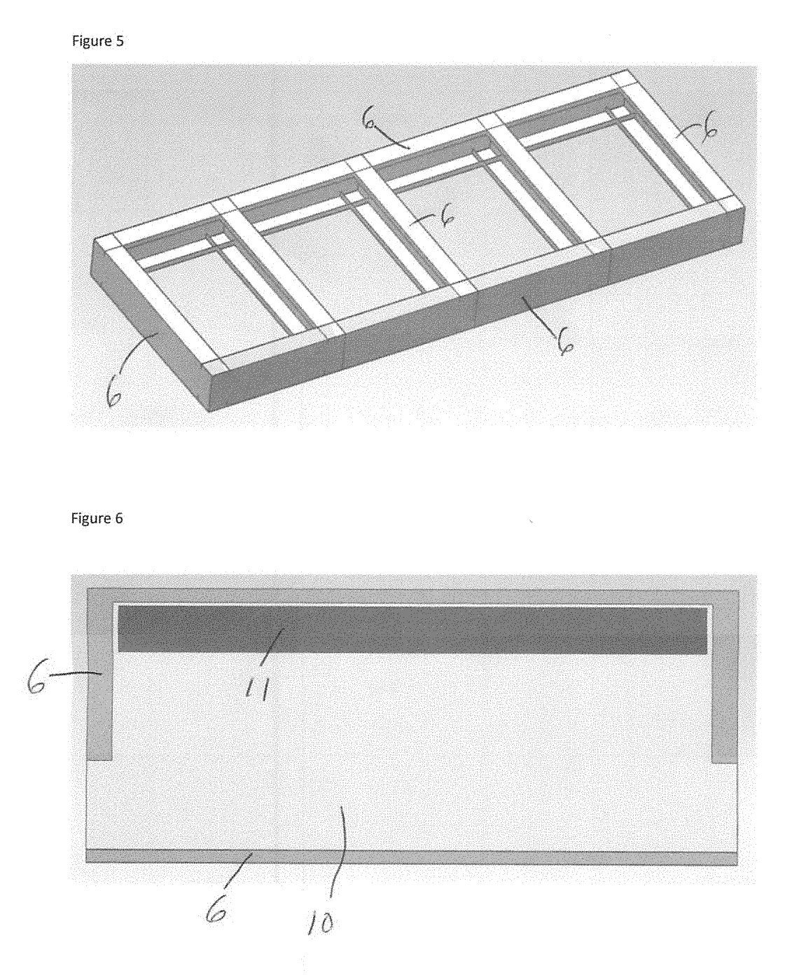

FIG. 5. Shows the design and construction of the frame 6, which will be built of standard wall framing studs or similar material due to its simplicity and low cost. The studs will be joined together to form the main frame using common connecting techniques such as riveting, soldering, welding or other viable techniques.

FIG. 6. Shows a top down view of the base section. There is a 3-inch gap in the back to allow the air circulation to continue around the tank. The top and bottom panes will be made of galvanized steel sheets due to its availability and structural integrity. The panes will be riveted or otherwise connected to the framing studs. The top pane will have the required cut-out to allow for top grill mounting. Galvanized steel will prevent corrosion damage, additional glossy/matte finish may be added.

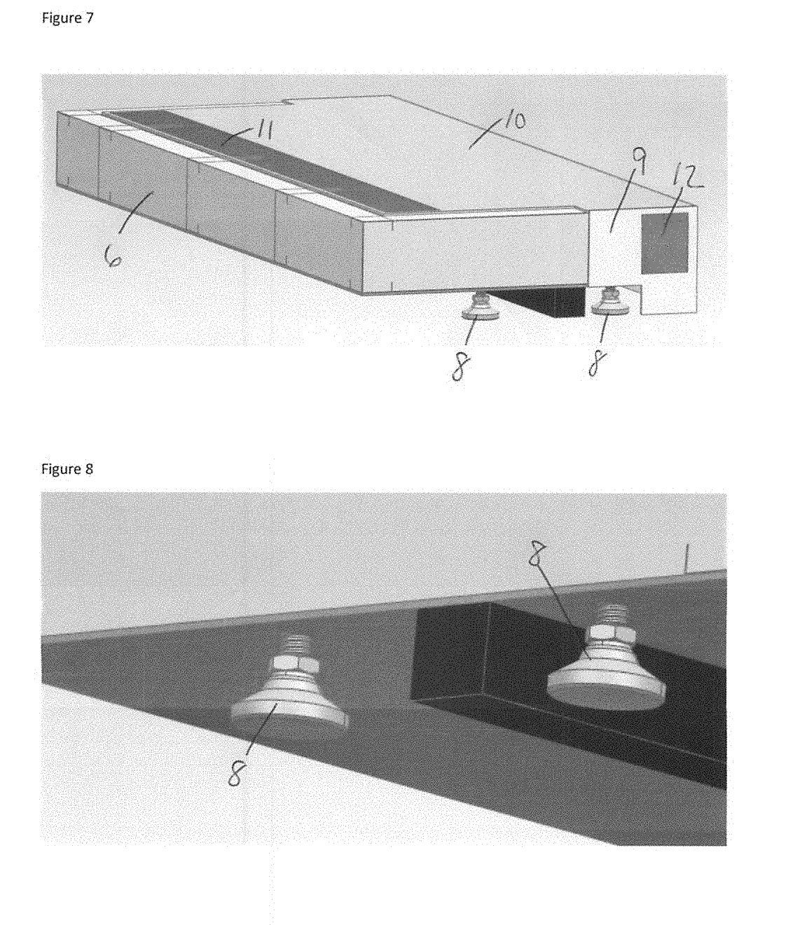

FIG. 7. The inside facing panels will be made of acrylic or vinyl due to its appearance and cost. The panels will be bolted to the framing studs. The panels will drop to cover the leveling legs once the unit is fully assembled. The side panels will mount hinged grills for air circulation and leveling leg serviceability. Grills for air circulation will be made of plastic due to its appearance and cost. The side grills will be hinged. Lateral mounting increases convective coefficient due to pressure drop across grill faces. The top grill will be dropped in place and be removable to service outside leveling legs.

FIG. 8. Leveling Legs 12 will be added to the Base ASM to overcome the bottom frame of the window and offset the taper on the outside window sill. The leveling legs will be fully adjustable (including angle).

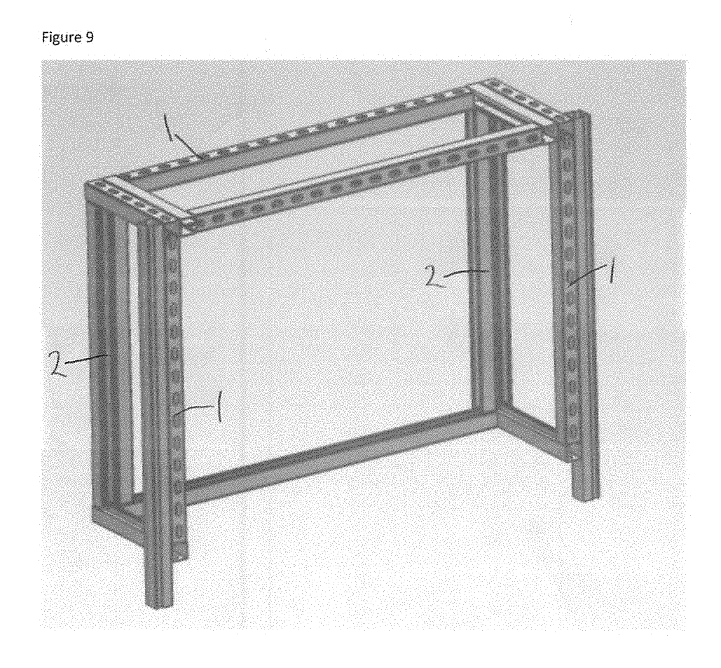

FIG. 9. The frame will be built using T channel struts 1 with a width of 1.625″ due to its availability and structural integrity. The struts will be bolted together using channel brackets. The struts will be riveted or otherwise connected to the Base ASM.

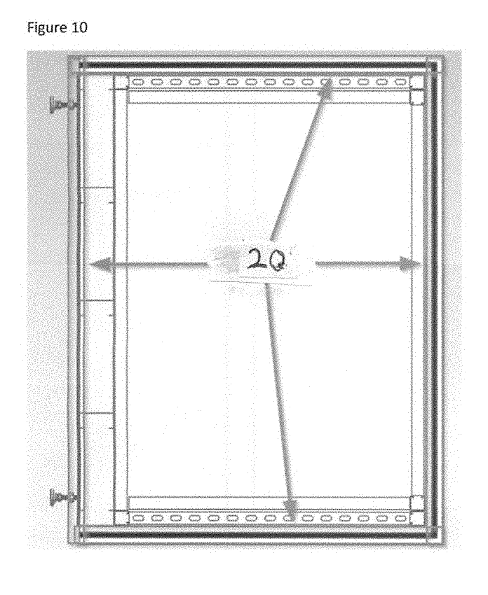

FIG. 10. Sealing will be accomplished through the use of weather-stripping 20 around the unit. The weather-stripping will be kept flush through the use of periodic screws around the mounting frame.

For the hardware a combination of screws & rivets will be used due to their simplicity, cost and performance. The paneling will be bolted on to allow for easy maintenance and replacement. The Base ASM will be riveted together. The Top ASM will be bolted together using channel brackets. The weather-stripping cover will be screwed into the existing window frame.

There will be a few different ways that the unit can be safely secured to the window, either with screws or clips, and a mounting bracket that we provide with all systems, allowing the installation (and later on, once operational, tank servicing and maintenance) to be done either from the inside, or the outside, or both.

For a customer to order a system, they will provide us with specific information regarding the window they're going to put our unit into—measurements of the window opening, the type of window (single hung, double hung, sliding, awning, casement, etc.), type of window housing (aluminum, vinyl, wood, etc.), where the nearest electrical outlet is located, if they want the tank to be flush with the face of the wall or protrude 6″ beyond the face of the wall, and where the home or office is located geographically (Boston, Los Angeles, London, etc.), which allows us to determine what insulation to use in manufacturing their unit.

In addition, the enclosure can be shipped either partially or fully assembled, depending on the chosen installation process. A completely assembled system that includes the peripheral flange will be sold to customers who are planning to self-install their system. This fully assembled version, built to order, is unable to pass completely through the window frame as the flange will overlap the window frame. The disadvantage to this version is that the amount of space for the tank inside the enclosure is slightly diminished.

A more optimized enclosure that allows for a slightly larger tank inside the enclosure can be purchased by customers who agree to have the system installed by an authorized installation company that will install the 2-piece enclosure according to installation instructions provided by the manufacturer.

The primary way a customer will order a system will be directly through our company via our website, www.windowquarium.com, or by calling our phone number. Online, there will be a configurator and form that will assist in gathering the customer's information that will help in determining the exact specifications of the system to be built for the customer and to enable us to provide a quote on the cost. Secondarily, indirect sales will occur through aquarium/pet store retailer and e-tailer dealers, and service/maintenance companies in the aquarium/terrarium industries.

Once a system is built to order for the customer, it gets packed and shipped to their desired location. After the customer unpacks the unit, they will follow the instructions detailing how the mounting bracket and system get placed onto the window sill, into the window, and secured to the window frame.

How does our invention operate? The designed construction elements of our enclosure and base hold out the outside elements—mainly temperature and light. The materials and construction of our unit will allow it to be weatherproof for all environments it is located in. In addition, the customer has options of how to block out the light from the upper section of the window above the tank, for example, using their existing shade, blind, or curtain, or by placing a variety of many different materials into that space, some of which may incorporate an additional artistic or design element, or perhaps going a step further and incorporating cabinetry and or shelving around the tank to create a more complete wall unit look.

The design and functionality of our base draws in the flow of the indoor air through the lower side sections and allows it to travel to the back of the base, up through the openings in the back top section of the base unit, up behind the tank and then above the tank towards the front, and back into the room. This inherent airflow assists in helping to keep the temperature regulated immediately surrounding the tank.

Our invention utilizes the architectural and structural design of the window frame and window sill to support and hold a terrarium or even an aquarium filled with water. Depending on the location of and access to the tank from inside and/or outside, the customer will have access to set up the tank as desired and then maintain and service the tank and its inhabitants as necessary.

1. An enclosure system installed within a window frame of a building comprising:
a cuboid base formed by framing studs and steel sheets comprising one opening on its top pane and two openings on its two side panes for allowing air circulation through the base;
a mounting frame that is fixed on top of the base and comprises at least eleven metal struts that forms a cuboid room;
one top panel and three side panels that cover four interior faces of the mounting frame; and
four acrylic panels that cover four exterior faces of the mounting frame.

2. An enclosure system as described in claim 1, wherein the cuboid base comprises at least two leveling legs.

3. An enclosure system as described in claim 1, wherein the metal struts are T-channel rods.

4. An enclosure system as described in claim 1, wherein the space between the interior and exterior faces of the mounting frame is filled with heat insulation materials.

5. A method of placing a box, container or tank in the exterior space next to a building through a window frame by using the enclosure system described in claim 1.
